(19) United States
(12) Patent Application Publication
(10) Pub. No.: US 2021/0144930 A1
(43) Pub. Date: May 20, 2021

(54) CONTAINER FOR PLANT CULTIVATION WITH SLOPING FERTIGATION TROUGHS

(71) Applicant: Emil V. BREZA, Beamsville, Ontario (CA)

(72) Inventor: Emil V. BREZA, Beamsville, Ontario (CA)

(21) Appl. No.: 17/045,140

(22) PCT Filed: Mar. 15, 2019
(86) PCT No.: PCT/CA2019/050322

§ 371 Date: Oct. 2, 2020

Related U.S. Application Data
(60) Provisional application No. 62/653,435, filed on Apr. 5, 2018.

(51) Int. Cl. A01G 9/04; A01G 9/02; A01G 31/06

(52) U.S. Cl. CPC A01G 9/047; A01G 31/06; A01G 9/022

(57) ABSTRACT

A plant container having a plant receptacle adapted to retain plant growth medium and defining an open cultivation end adapted for emergence of a plant system therefrom. The plant container features at least one fertigation supply trough and at least one fertigation drainage trough, each sloping inwardly from the open cultivation end. When the plant container is oriented such that the at least one fertigation supply trough is facing upward, liquid received in the fertigation supply trough flows along the fertigation supply trough away from the open cultivation end, through at least one fertigation supply aperture into and through the interior volume of the plant receptacle, into and along the fertigation drainage trough toward the open cultivation end, and exits by way of at least one fertigation drainage aperture. Typically a series of plant containers are received in end-to-end relation in a channel of a vertical plant cultivation tower.

### BACKGROUND

There are a number of drawbacks with existing plant cultivation systems.

### SUMMARY

Plants to be cultivated are carried by one or more plant carrier inserts that are removably installed in modular magazines, which may take the form of towers. The towers are received upright in tower receptacles of an isolation and fertigation infrastructure unit that includes an air circulation system to create a microclimate for the plants and a fertigation system to supply water to the plants. The towers each have a longitudinally extending channel defined therein, with the channel being adapted to removably slidably receive at least one type of plant carrier insert to thereby support the plants in the tower. The modular nature of the towers and the plant carrier inserts allows plants of different types, different sizes and different stages of maturity to be grown using the same isolation and fertigation infrastructure unit(s) by changing the type of tower(s) and/or the type of plant carrier insert(s).

### BRIEF DESCRIPTION OF THE DRAWINGS

These and other features will become more apparent from the following description in which reference is made to the appended drawings wherein:

FIG. 1 is a top perspective view of an exemplary isolation and fertigation infrastructure unit;

FIG. 2 is a side view of the isolation and fertigation infrastructure unit of FIG. 1;

FIG. 3 is a top plan view of the isolation and fertigation infrastructure unit of FIG. 1;

FIG. 4 is a perspective view of a first exemplary plant carrier insert for a plant cultivation tower;

FIG. 5 is a perspective view of the plant carrier insert of FIG. 4 with a plurality of plant units disposed in receptacles thereof;

FIG. 6 is a side cross-sectional view taken along the line 6-6 in FIG. 4;

FIG. 7 is another perspective view of the plant carrier insert of FIG. 4 with a plurality of plant units disposed in receptacles thereof;

FIG. 8 is a side cross-sectional view taken along the line 8-8 in FIG. 7;

FIGS. 9 and 10 show installation of the plant carrier insert of FIG. 4 with plant units, as shown in FIG. 5 into a first exemplary plant cultivation tower;

FIG. 11 is a perspective view showing installation of an assembly of a plant cultivation tower and plant carrier insert(s), as shown in FIG. 10, in a tower receptacle of the isolation and fertigation infrastructure unit of FIG. 1;

FIG. 12 is a perspective view showing all of the tower receptacles of the isolation and fertigation infrastructure unit of FIG. 1 occupied by instances of the plant cultivation tower shown in FIG. 9;

FIG. 13 is a detail view of a portion of FIG. 12;

FIGS. 14 through 16 show operation of an air delivery system of the isolation and fertigation infrastructure unit of FIG. 1;

FIG. 17 shows operation of a fertigation system of the isolation and fertigation infrastructure unit of FIG. 1 in conjunction with the plant cultivation tower and plant carrier insert(s), as shown in FIG. 10;

FIG. 18 is a first plan view of a second exemplary plant carrier insert, according to an aspect of the present disclosure;

FIG. 19 is a first side elevation view of the plant carrier insert of FIG. 18;

FIG. 20 is a first end view of the plant carrier insert of FIG. 18;

FIG. 21 is a second end view of the plant carrier insert of FIG. 18;

FIG. 22 is a second plan view of the plant carrier insert of FIG. 18;

FIG. 23 is a second side elevation view of the plant carrier insert of FIG. 18;

FIG. 24 is a perspective view of the plant carrier insert of FIG. 18;

FIG. 25 is a perspective view showing installation of plant containers into plant receptacles of the plant carrier insert of FIG. 18;

FIG. 26 is an end view showing relative positioning of the of plant containers in the plant receptacles of the plant carrier insert of FIG. 18;

FIG. 27 is a bottom perspective view of one of the plant containers of FIG. 25;

FIGS. 28 to 30 show installation of the plant carrier insert of FIG. 18 with plant containers, as shown in FIG. 25, into a second exemplary plant cultivation tower;

FIG. 31 is a perspective view of a third exemplary plant carrier insert, according to an aspect of the present disclosure;

FIG. 32 is a first side elevation view of the plant carrier insert of FIG. 31;

FIG. 33 is a first end view of the plant carrier insert of FIG. 31;

FIG. 34 is a second side elevation view of the plant carrier insert of FIG. 31;

FIG. 35 is a second end view of the plant carrier insert of FIG. 31;

FIG. 36 is a first plan view of the plant carrier insert of FIG. 31;

FIG. 37 is a second plan view of the plant carrier insert of FIG. 31;

FIGS. 38 to 40 show installation of plant carrier inserts as shown in FIG. 31 into a third exemplary plant cultivation tower; and

FIG. 41 shows operation of a fertigation system of the isolation and fertigation infrastructure unit of FIG. 1 in conjunction with the plant cultivation tower and plant carrier insert(s), as shown in FIG. 40.

### DETAILED DESCRIPTION

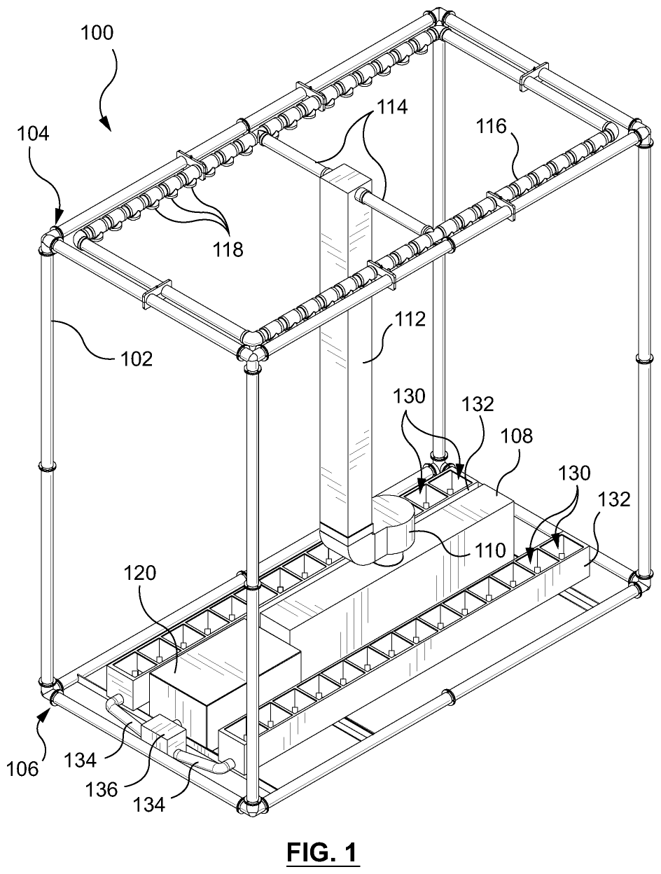

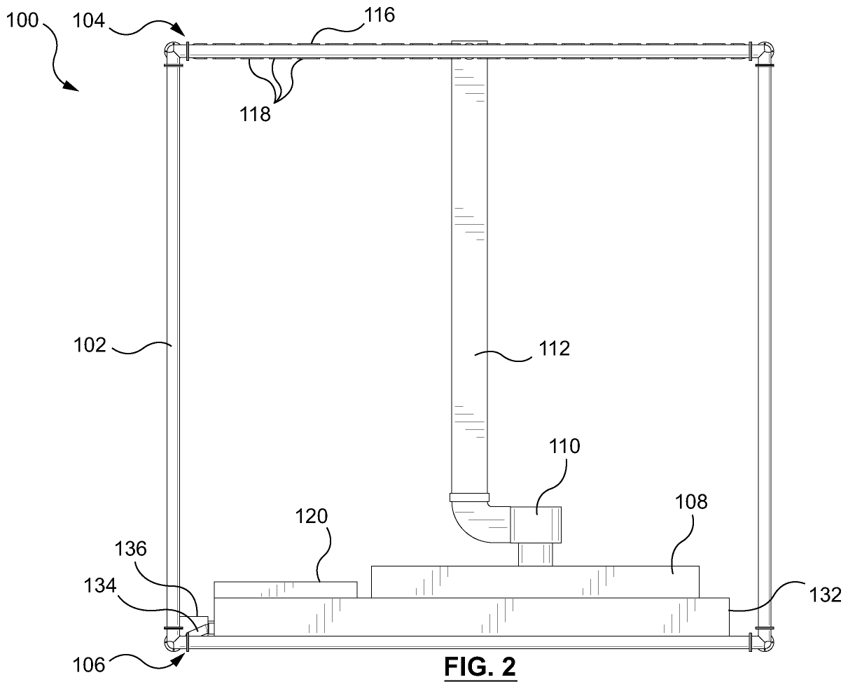

Reference is first made to FIG. 1, which shows an exemplary isolation and fertigation infrastructure unit, indicated generally at reference 100. The term “fertigation”, as used herein, refers to irrigation in which the water also contains fertilizer/nutrients and other water-soluble materials to be delivered to the plants. The isolation and fertigation infrastructure unit 100 comprises a main frame 102 which supports an air delivery system and a fertigation system. Although not shown in the drawings, a lighting system (e.g. light emitting diodes of a wavelength and intensity tuned to the plants being grown) may be carried by the main frame at the upper end 104 thereof, or may be suspended above the main frame 102 (e.g. from a ceiling) in registration therewith. For example, lighting systems sold under the trademark MetaRail™ by AgricUltra Advancements Inc., having an address at 1100 S Service Rd, Suite 223, Stoney Creek, Ontario, Canada L8E 0C5.

The air delivery system comprises an air supply plenum 108 disposed at a lower end 106 of the main frame 102 and which draws air from beneath the plenum at ground/floor level. An air supply fan 110 draws air from the plenum 108 which communicates, through supply duct 112 and tubing 114, with a plant canopy air manifold 116 carried by the main frame 102 at the upper end 104 of the main frame 102. Although not shown, heating/cooling, humidification/dehumidification and CO₂ addition/scrubbing of the air may also be provided within the air circulation system. The plant canopy air manifold 116 comprises a plurality of spaced-apart air nozzles 118 which cooperate to form an air curtain to isolate plants being cultivated in the isolation and fertigation infrastructure unit 100, as described further below. The air curtain creates a controlled environment (air temperature, air humidity, air velocity, CO₂ level) for plants being cultivated in the isolation and fertigation infrastructure unit 100. The air circulation system shown and described is merely one exemplary implementation, and other air circulation systems can also be used. For example, in an alternate implantation, the plant canopy air manifold 116 may communicate with a plurality of depending air pipes, rather than air nozzles 118, and the air pipes (not shown) may each have a plurality of nozzles arranged to blow air outwardly.

The fertigation system comprises a fertigation reservoir 120 which contains a volume of water that has been treated with fertilizer, nutrients and/or other materials, in accordance with the plants to be cultivated. The fertigation system further comprises a fertigation pump (not shown) which draws water from the fertigation reservoir 120 and pumps it through fertigation tubing (not shown) to a fertigation manifold (not shown) at the upper end 104 of the main frame. The fertigation manifold delivers the water to the upper ends of plant cultivation towers (not shown in FIG. 1), as described further below. Each of the towers is received in an individual tower receptacle 130 in a pair of tower return troughs 132 at the lower end 106 of the main frame 102, towards the outside thereof. The tower return troughs 132 receive run-off from the plant cultivation towers, which drains through return tubing 134 into a fertigation return sump 136. A return pump (not shown) pumps the run-off from the fertigation return sump 136 back to the fertigation reservoir 120; a check valve (not shown) may be interposed between the fertigation return sump 136 and the fertigation reservoir 120 to prevent backflow. Alternatively, the fertigation return sump 136 may feed into the upper portion of the fertigation reservoir 120. While the term “fertigation” is used throughout, it will be appreciated that the fertigation system can function as an irrigation system to deliver water without fertilizer, nutrients or other materials, depending on the application. The fertigation system shown and described is merely one exemplary implementation, and other fertigation/irrigation systems can also be used.

Although only a single isolation and fertigation infrastructure unit 100 is shown for purposes of illustration, it will be appreciated that a plurality of isolation and fertigation infrastructure units 100 may be arranged in end-to-end relation to form a row, and a plurality of such rows may be arranged side by side to form aisles therebetween.

According to the present disclosure, the plants to be cultivated are carried in individual housings which, in the illustrated embodiments, take the form of modular towers that are received in tower receptacles 130 in the tower return troughs 132 at the lower end 106 of the main frame 102 of the isolation and fertigation infrastructure unit 100. Thus, broadly speaking, each housing comprises a tower having a longitudinally extending channel defined therein, with the channel being adapted to removably slidably receive one or more plant carrier inserts. The modular nature of the towers allows plants of different types, different sizes and different stages of maturity to be grown using the same isolation and fertigation infrastructure unit(s) 100 by changing the type of tower(s) and/or the type of plant carrier insert(s). Although not shown in the drawings in order to provide clearer illustration of the components, the main frame 102 may include support bars positioned to support the upper portions of the towers for improved stability.

A number of exemplary towers and plant carrier inserts will now be described.

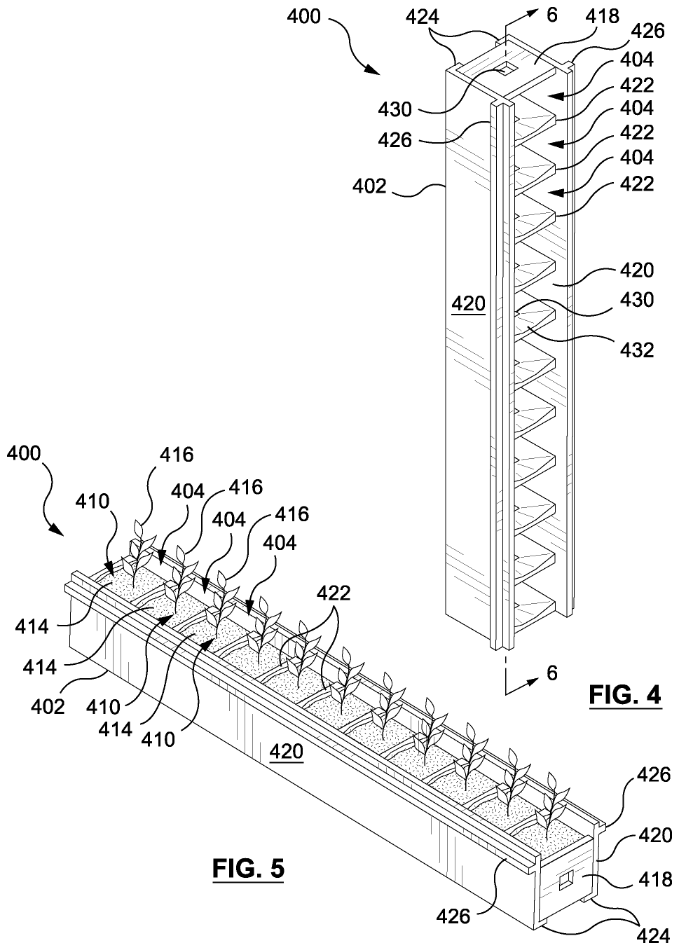

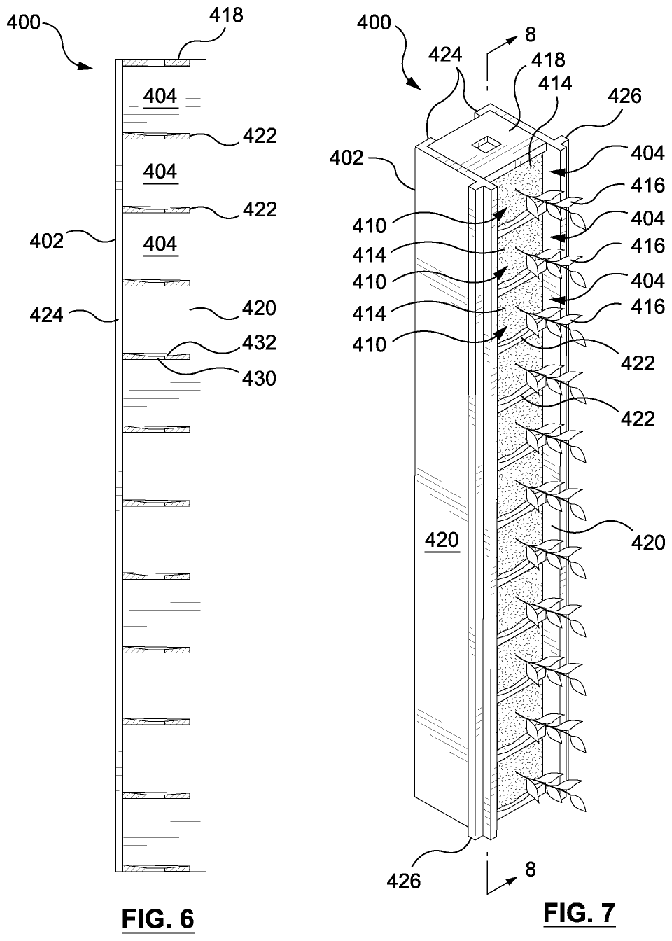

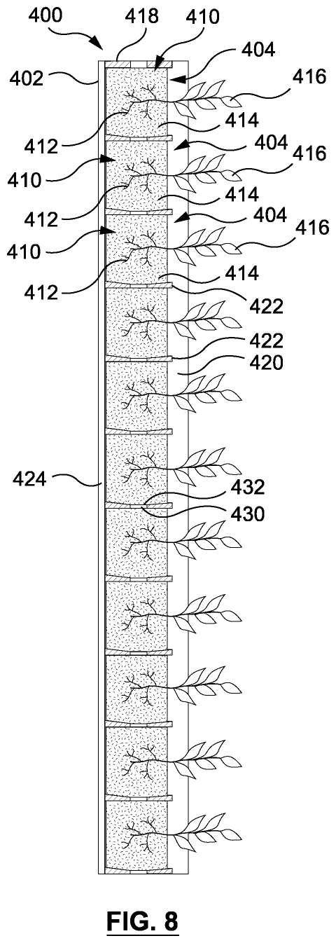

With reference now to FIGS. 4 to 8, a first exemplary plant carrier insert for a plant cultivation tower is indicated generally by reference 400. The first exemplary plant carrier insert 400 comprises a longitudinally extending support element 402 having a plurality of longitudinally spaced plant receptacles 404, with each of the plant receptacles 404 being adapted to receive and support a plant unit 410. FIGS. 4 and 6 show the plant receptacles 404 empty, and FIGS. 6, 7 and 8 show each of the plant receptacles 404 with a respective plant unit 410 received therein. The term “plant unit”, as used herein, refers to (depending on the growth stage) either a seed or bulb encased in a quantity of growth medium such as soil, rockwool, etc. or, as shown in FIG. 8, a root system 412 encased in a quantity of growth medium 414 with a shoot system 416 emerging from the growth medium 414, either with or without a container (e.g. a pot). FIGS. 6, 7 and 8 show plant units 410 without any containers, received directly in the plant receptacles 404 of the plant carrier insert 400.

In the exemplary embodiment, the first exemplary plant carrier insert 400 comprises a superior end wall 418 and a pair of opposed, spaced-apart, longitudinally extending side facings 420 with the end wall 418 and a plurality of longitudinally spaced partitions 422 extending between the side facings 420 to define the plant receptacles 404. The side facings 420 have inwardly projecting, longitudinally extending flanges 424 at one end thereof and outwardly projecting guide rails 426 at the other end thereof, leaving the plant receptacles 404 open at both ends of the side facings 420. The illustrated structure is one exemplary construction, and is not intended to be limiting.

Each of the plant receptacles 404 has a fertigation port in fluid communication with an adjacent one of the plant receptacles 404. In the exemplary illustrated embodiment, each fertigation port comprises a square aperture 430 formed through a respective partition 422 separating adjacent plant receptacles 404. Although a single square aperture is shown in the illustrated embodiment, other embodiments may have multiple apertures and/or apertures of other shapes. When the support element 402 is oriented vertically, as shown in FIGS. 4 and 6 to 8, fluid supplied to an uppermost one of the receptacles can flow through the fertigation ports 430 through successive plant receptacles 404 to a lowermost one of the plant receptacles 404 under the influence of gravity. A concave region 432 surrounds each fertigation port 430 to facilitate drainage. Typically first exemplary plant carrier insert 400 will be between 12 and 18 inches long.

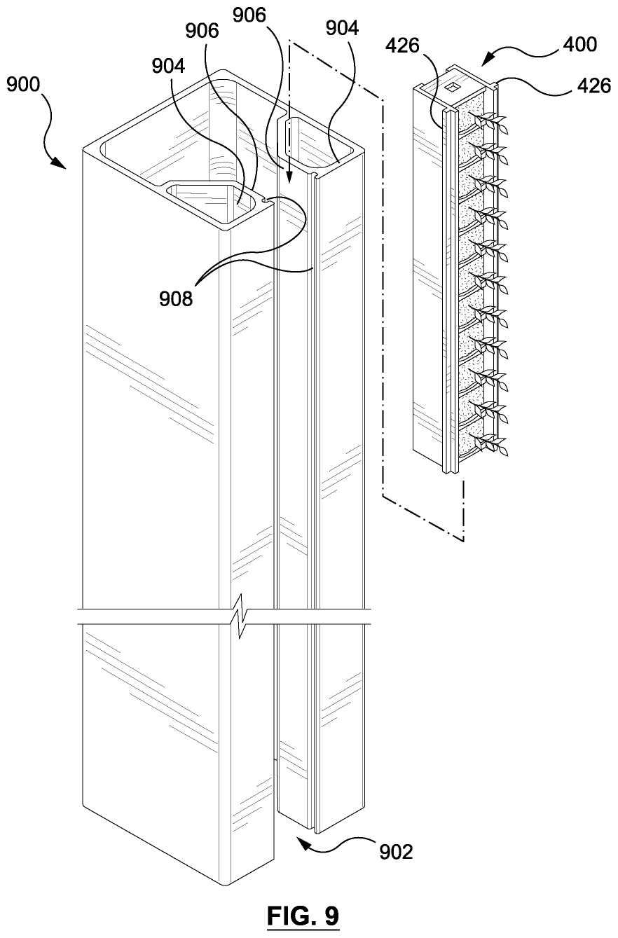

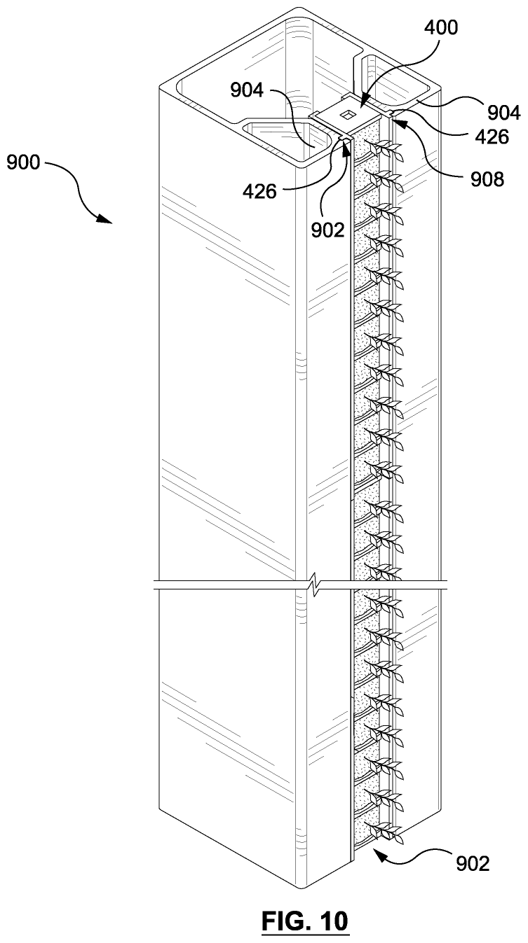

Reference is now made to FIGS. 9 and 10, which show installation of the first exemplary plant carrier insert 400 into a first exemplary plant cultivation tower, indicated generally by reference 900. The first exemplary plant cultivation tower 900 has a longitudinally extending channel 902 defined therein. The channel 902 is adapted to removably slidably receive the first exemplary plant carrier insert 400. In the illustrated embodiment, the first exemplary plant cultivation tower 900 is of generally C-shaped cross section, with the channel 902 being formed by two longitudinally extending, hollow inward projections 904. The inner faces 906 of the inward projections 904 have opposed longitudinally-extending guide grooves 908 that are dimensioned to receive the guide rails 426 on the first exemplary plant carrier insert 400 so as to maintain the plant carrier insert 400 within the channel 902. Thus, the first exemplary plant carrier insert 400 can be slid into the channel 902. Depending on the length of the plant carrier insert 400 and the height of the first exemplary plant cultivation tower 900, either a single instance of the first exemplary plant carrier insert 400 may be received in the channel 902, or a series of instances of the first exemplary plant carrier insert 400 may be received in the channel 902 in end-to-end relation, as shown in FIG. 10. Accordingly, the first exemplary plant cultivation tower 900 is a housing for a plant cultivation system, which comprises a magazine having a longitudinally extending channel 902 defined therein, and, when the first exemplary plant carrier insert 400 is installed, the channel 902 has removably slidably received therein a plurality of distinct individual plant receptacles 904 arranged in end-to-end relation.

Typically the first exemplary plant cultivation tower 900 will range from five feet to eight feet in height (although other heights are also contemplated). The maximum height of the first exemplary plant cultivation tower 900 is only limited by the configuration of the isolation and fertigation infrastructure unit 100.

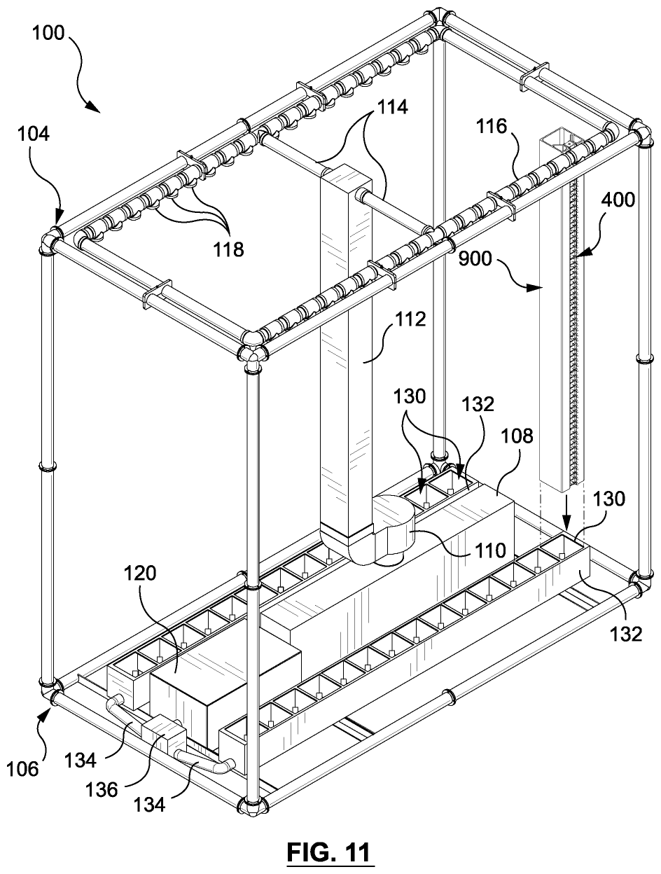

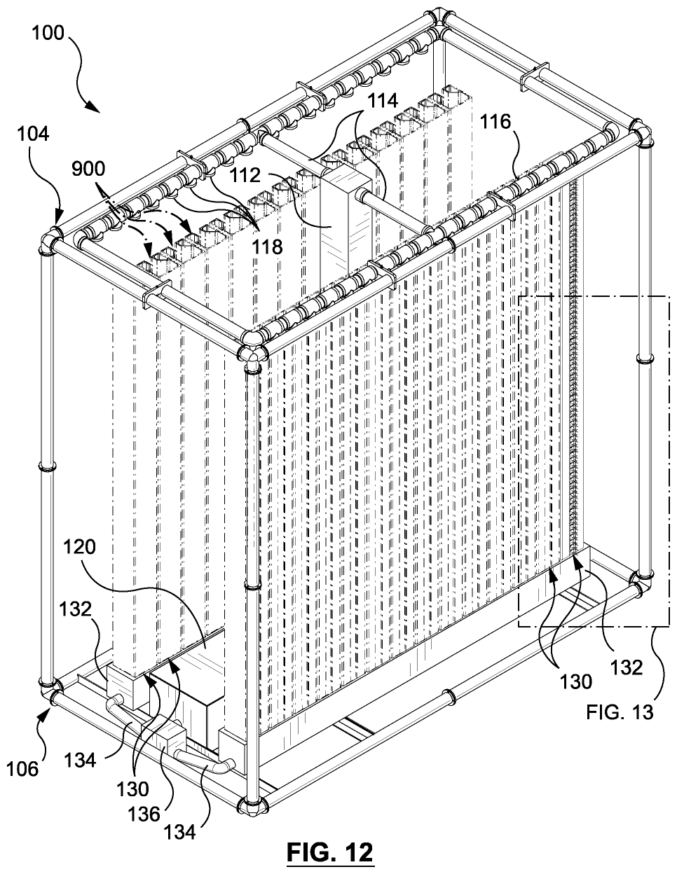

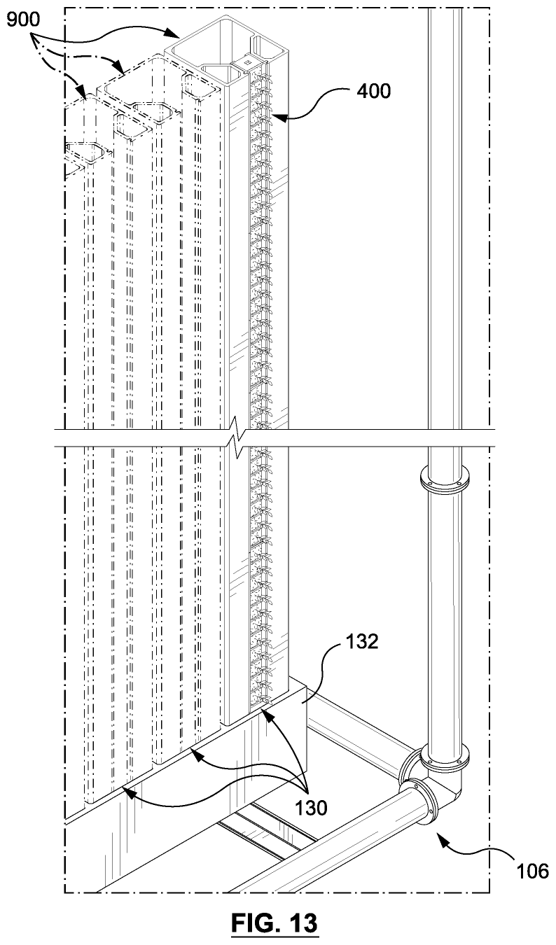

Once the plant carrier insert(s) 400 are positioned in the channel 902, the entire assembly (plant cultivation tower 900 and plant carrier insert(s) 400) may then be installed in one of the tower receptacles 130 in one of the tower return troughs 132, as shown in FIG. 11, and this process may be repeated so that all of the tower receptacles 130 are occupied by instances of the first exemplary plant cultivation tower 900, as shown in FIGS. 12 and 13.

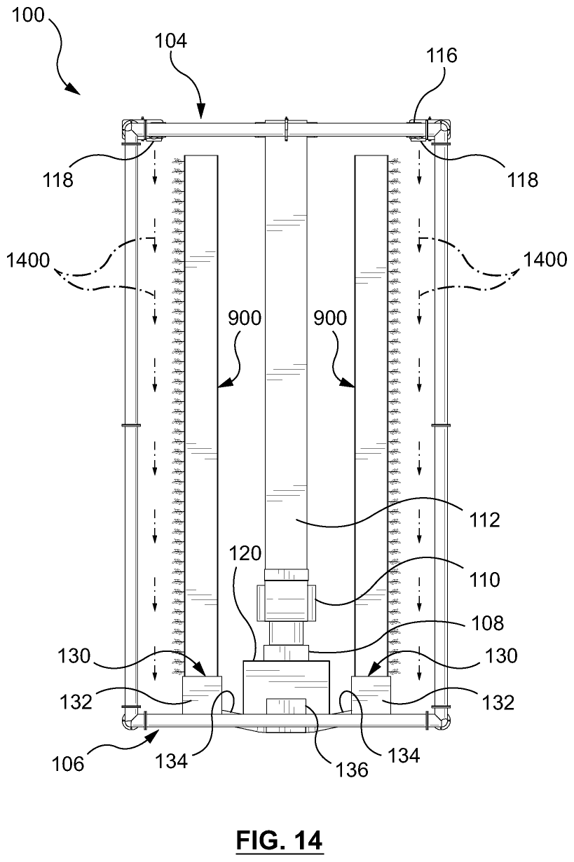

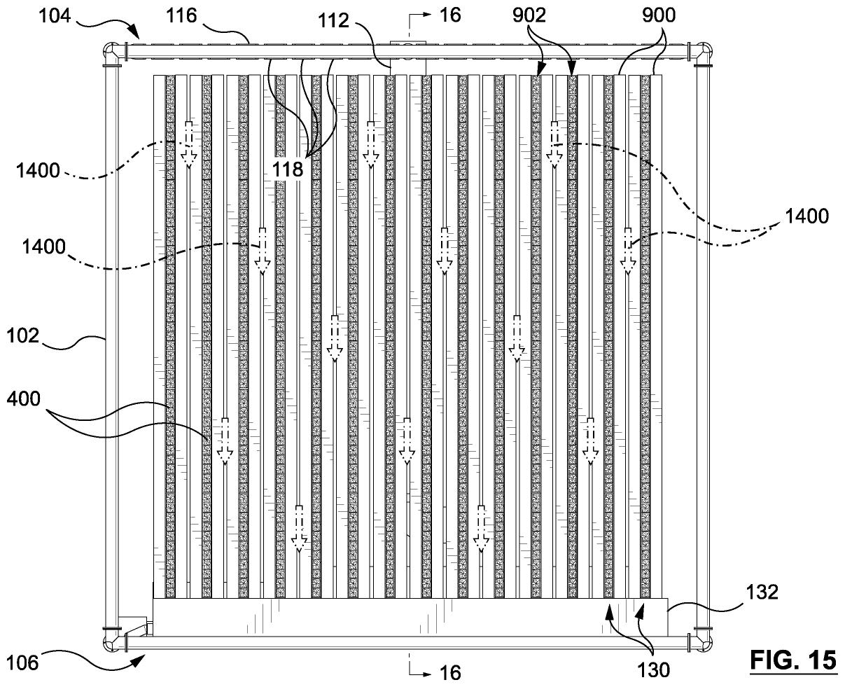

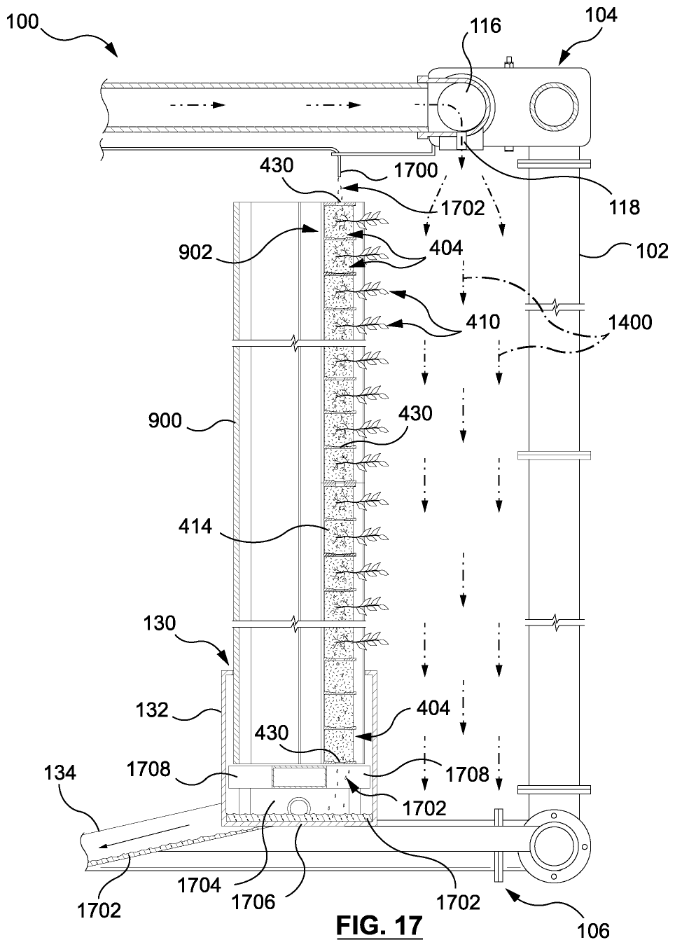

FIGS. 14 through 17 illustrate interaction between the isolation and fertigation infrastructure unit 100 and the first exemplary plant cultivation tower 900 and first exemplary plant carrier insert(s) 400. More particularly, FIGS. 14 through 16 show operation of the air delivery system and FIG. 17 shows operation of the fertigation system.

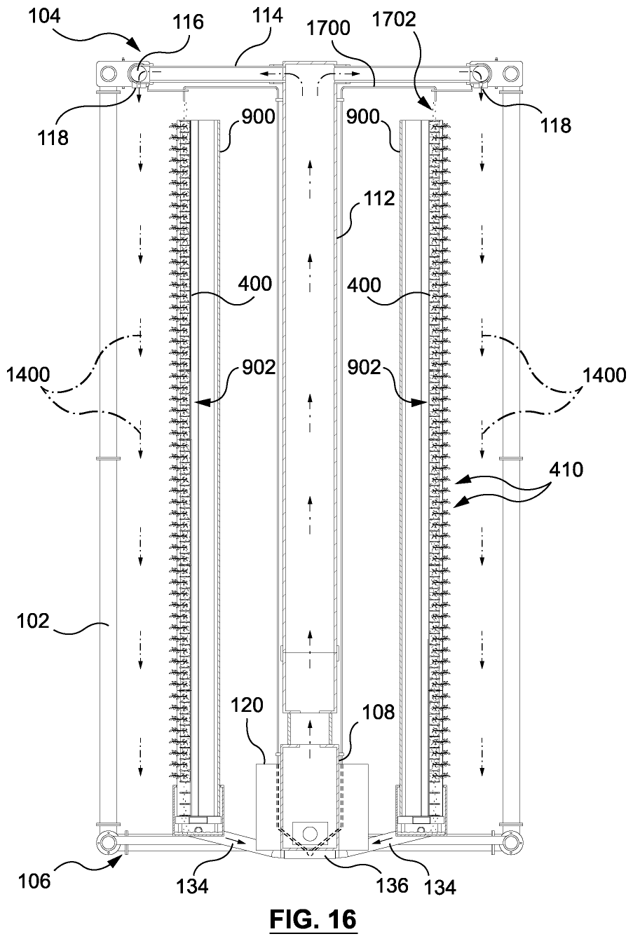

As shown specifically in FIG. 16 (and also in FIG. 17), air is drawn by the fan 110 from ground level into an open underside of the air supply plenum 108. Although not shown in the drawings, the air supply plenum 108 includes a coil and/or other apparatus to condition the air for humidity and temperature. The conditioned air is then pumped by the fan 110 out of the air supply plenum 108 and through the supply duct 112 and tubing 114 into the plant canopy air manifold 116. The air is then forced through the air nozzles 118 of the plant canopy air manifold 116 at suitable speed and pressure to form an air curtain, denoted by arrows 1400, over the plant carrier inserts 400 in the channels 902 of the plant cultivation towers 900. The air curtain 1400 enables creation of a “microclimate” around the plant units 410, independent of the climate of a building or other environment in which the isolation and fertigation infrastructure unit 100 located. In an embodiment in which the plant canopy air manifold 116 communicates with a plurality of depending air pipes, rather than air nozzles 118, the pipes may be configured so that the nozzles in the pipes blow air through at least a portion of canopy.

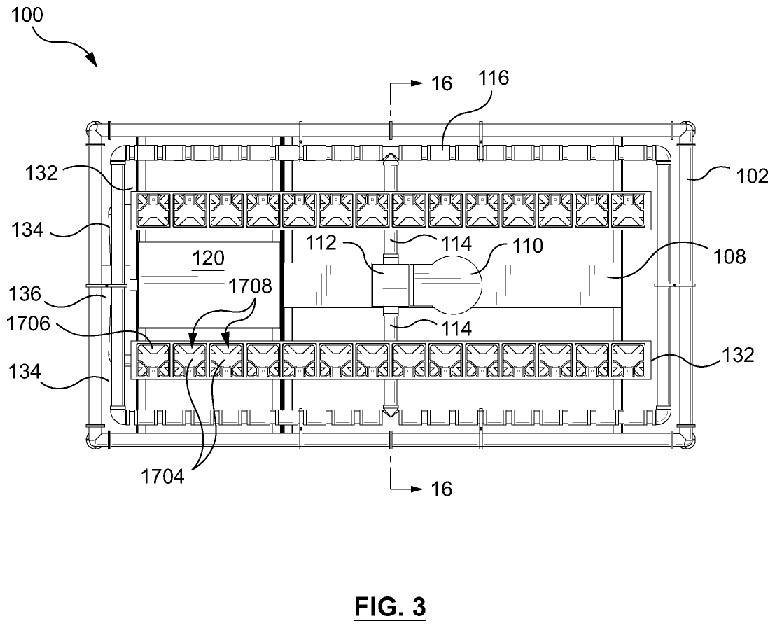

Referring now to FIG. 17, it can be seen that a fertigation tube 1700, supplied by the fertigation pump (not shown) from the fertigation reservoir 120 (FIG. 1) is positioned over each of the plant cultivation towers 900, in registration with the channel 902 thereof. Moreover each fertigation tube 1700 is positioned so that, when one or more plant carrier inserts 400 are received in the channel 902, the fertigation tube 1700 will be in registration with the uppermost fertigation port 430 to supply water 1702 to the plant units 410 in the plant receptacles 404 of the plant carrier insert(s) 400. The water 1702 can flow through the fertigation ports 430 through successive plant receptacles 404 (after saturating the growth medium 414 of the plant unit 410 therein) to a lowermost one of the plant receptacles 404 under the influence of gravity. As best seen in FIG. 17 (also shown in FIG. 3), within the tower receptacle 130, there is a tower support platform 1704 elevated above the floor 1706 of the tower return trough 132 and having drainage apertures 1708, at least one of which is in registration with the channel 902 and hence with the lowermost fertigation port 430. Thus, the water 1702, after reaching the lowermost receptacle 404, can drain through the lowermost fertigation port 430 and the drainage apertures 1708 to the floor 1706 of the tower return trough 132, which feeds into the return tubing 134 to drain the water 1702 into the fertigation return sump 136 (FIG. 14) for recycling.

Thus, FIGS. 12, 15 and 16 show a plant cultivation system comprising a plurality of vertically arranged modular towers 900 functioning as a magazine that vertically loads a plurality of distinct, individual plant receptacles (as distinguished from simply filling the channel 902 with a continuous column of growth medium). This plant cultivation system further comprises an air delivery system (e.g. air supply plenum 108, supply duct 112, tubing 114, the plant canopy air manifold 116 and nozzles 118) adapted to protect plants growing in the plant receptacles 402. This plant cultivation system still further comprises a fertigation system (e.g. fertigation reservoir 120, fertigation pump, fertigation tubing, fertigation manifold and fertigation tubes 1700) adapted to fertigate the plants from the upper ends of the towers 900 and recover water for recycling at the lower ends of the towers 900.

Once the plant units 410 have reached a desired stage of maturity, the plant cultivation towers 900 can be removed from the isolation and fertigation infrastructure unit 100 and the plant carrier insert(s) 400 can be slid out of the channel 902 thereof for further processing. For example, the plant units 410 may be extracted from the plant receptacles 404 of the plant carrier insert(s) 400 for transplantation and the plant carrier insert(s) 400 can be reused or recycled.

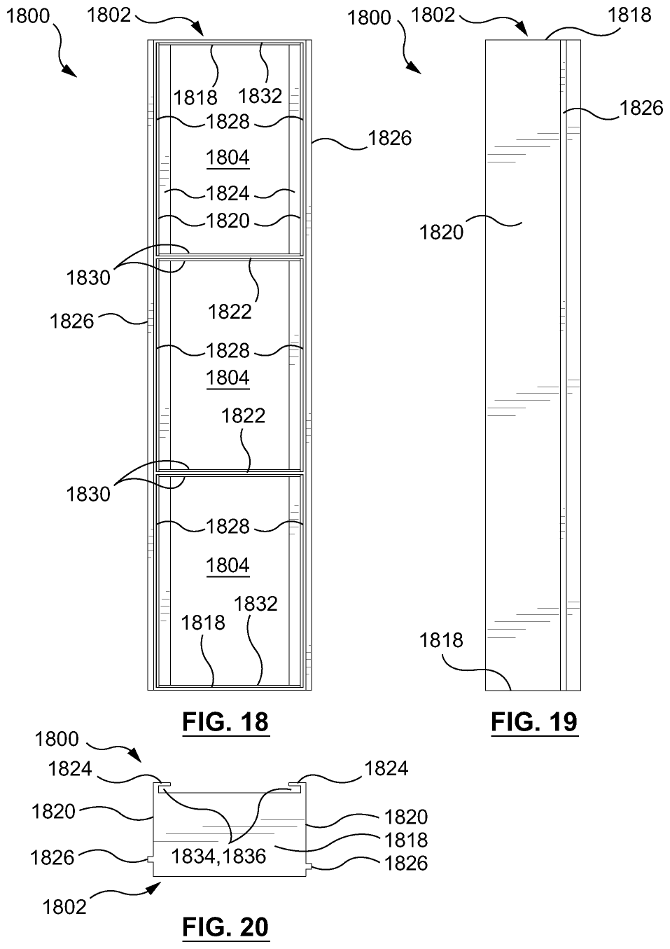

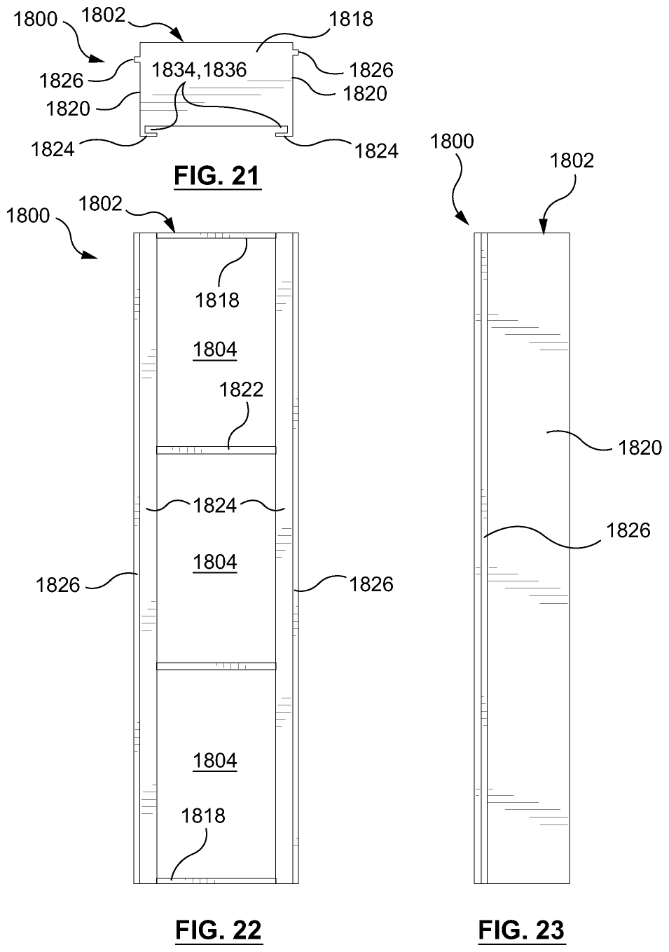

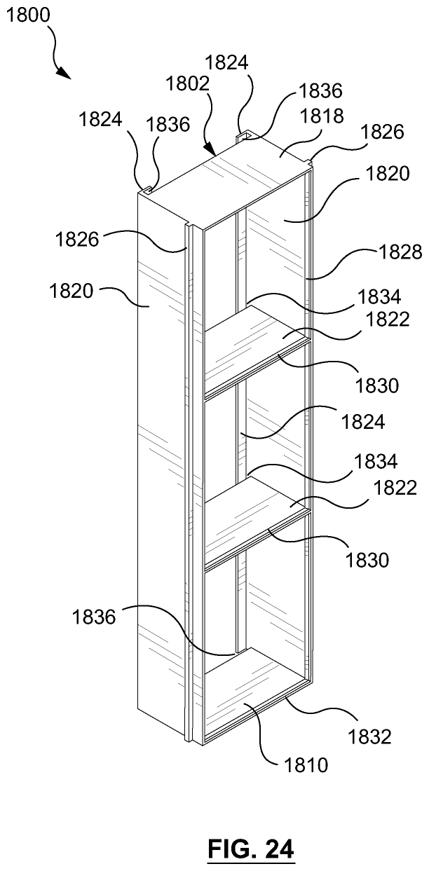

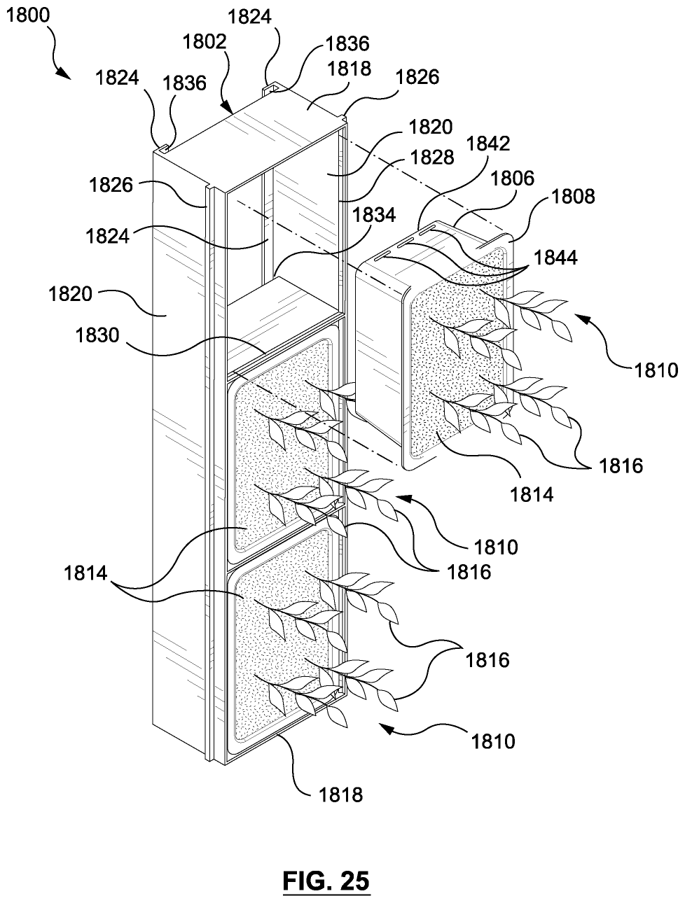

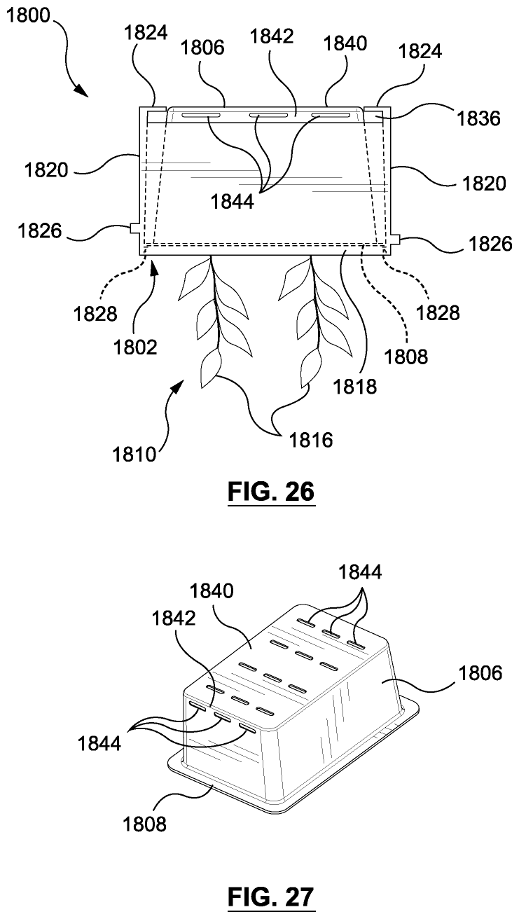

With reference now to FIGS. 18 to 25, a second exemplary plant carrier insert for a plant cultivation tower is indicated generally by reference 1800. The second exemplary plant carrier insert 1800 comprises a longitudinally extending support element 1802 having a plurality of longitudinally spaced plant receptacles 1804, with each of the plant receptacles 1804 being adapted to receive and support a plant unit 1810 (FIGS. 26 and 27). In the exemplary embodiment, the second exemplary plant carrier insert 1800 comprises a pair of opposed end walls 1818 and a pair of opposed, spaced-apart, longitudinally extending side facings 1820 with the end walls 1818 and a plurality of longitudinally spaced partitions 1822 extending between the side facings 1820 to define the plant receptacles 1804. The side facings 1820 have inwardly projecting, longitudinally extending flanges 1824 at one end thereof and outwardly projecting guide rails 1826 at the other end thereof, leaving the plant receptacles 1804 open at both ends of the side facings 1820. As best seen in FIGS. 20 and 21, the guide rails 1826 are offset relative to one another. In addition, the side facings 1820, partitions 1822 and end walls 1818 have respective inwardly projecting ridges 1828, 1830, 1832 that cooperate to form an annular support projection at the mouth of each receptacle 1804, opposite the longitudinally extending flanges 1824. This merely one exemplary construction, and is not intended to be limiting.

Like the plant receptacles 404 in the first exemplary plant carrier insert 400, in the second exemplary plant carrier insert 1804 each of the plant receptacles 1804 has a fertigation port in fluid communication with an adjacent one of the plant receptacles 1804. In the second exemplary plant carrier insert 1804 embodiment, as best seen in FIGS. 20, 21 and 27, each fertigation port is formed by gaps 1834 between the longitudinally extending flanges 1824 and the partitions 1822. Similar gaps 1836 are formed between the longitudinally extending flanges 1824 and the end walls 1818. When the support element 1802 is oriented vertically, as shown in FIGS. 18, 19 and 22 to 25, fluid supplied to an uppermost one of the receptacles can flow through the fertigation ports 430 through successive plant receptacles 1804 to a lowermost one of the plant receptacles 1804 under the influence of gravity through the gaps 1834 and, where a plurality of plant carrier inserts 1800 are arranged end to end, through the gaps 1836 from one plant carrier insert 1800 to the next. Typically the second exemplary plant carrier insert 1800 will be between 12 and 18 inches long.

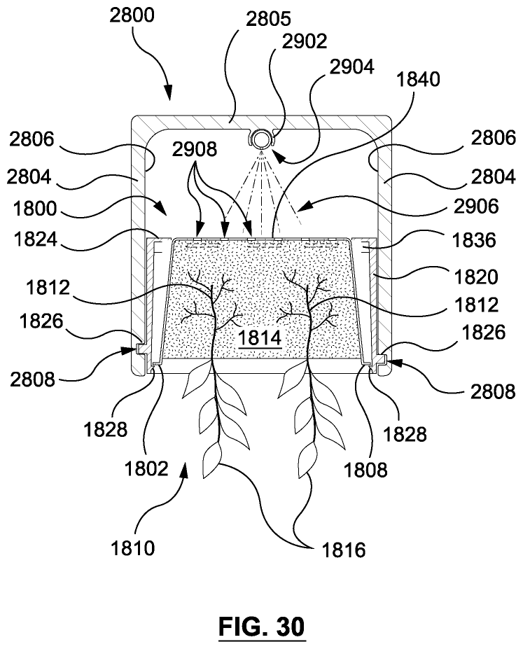

FIGS. 26 and 27 show plant units 1810 which comprise, in addition to the root system 1812 (see FIG. 30) encased in a quantity of growth medium 1814 with a shoot system 1816 emerging from the growth medium 1814, an open-topped, generally parallelepipedic plant container 1806 having curved corners, an open top and an outwardly extending superior peripheral flange 1808. This type of container is often referred to as a “clamshell” housing, as the peripheral flange 1808 is adapted to receive via snap-fit a correspondingly shaped lid or cover (not shown) to protect the shoot system 1816 when the plants (i.e. container, plant unit and cover) are transported and then displayed for sale. The cover is typically made from transparent plastic so as to allow light to reach the shoot system 1816. The plant units 1810, including the containers 1806, are received in the plant receptacles 1804 of the second exemplary plant carrier insert 1800 with the generally flat bottom 1840 of the plant container 1806 interference fit beneath the longitudinally extending flanges 1824 and the peripheral flange 1808 resting against the inwardly projecting ridges 1828, 1830, 1832 (see FIG. 18) to releasably retain the plant container 1806, and therefore the plant unit 1810, in the receptacle 1804. Alternatively, the bottom 1840 of the plant container 1806 may simply rest on the longitudinally extending flanges 1824. Typically, the superior peripheral flange 1808 will be resilient so that the plant container 1806 can be removed by deliberate flexing of the superior peripheral flange 1808 until it is able to clear the inwardly projecting ridges 1828, 1830, 1832 but has sufficient stiffness to hold the plant container 1806 and plant unit 1810 in place until deliberately removed. Thus, each of the plant receptacles 1804 is adapted to releasably receive a clamshell housing (e.g. plant container 1806).

As can be seen in FIGS. 26 and 27, in the illustrated embodiment a plurality of fertigation apertures 1844 are formed through the portions 1842 of the sidewalls of the plant container 1806 that will, when the plant container 1806 is received in the receptacle 1804, be in registration with the fertigation port formed by the gaps 1834, 1836. Thus, water entering the gaps 1834, 1836 can flow into the plant container 1806 through the uppermost fertigation apertures 1844, through the growth medium 1814 and out of the lowermost fertigation apertures 1844 toward the plant container 1806 below. Additionally, or alternatively, misting apertures 2908 (see FIG. 30) are formed through the bottom 1840 of the plant container 1806, the purpose of which will be described further below.

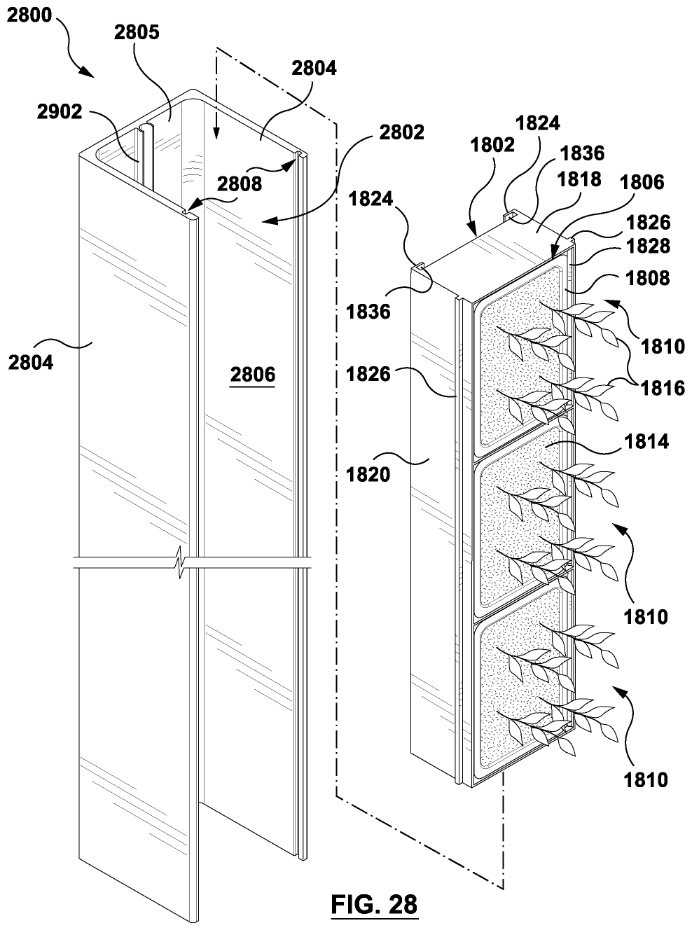

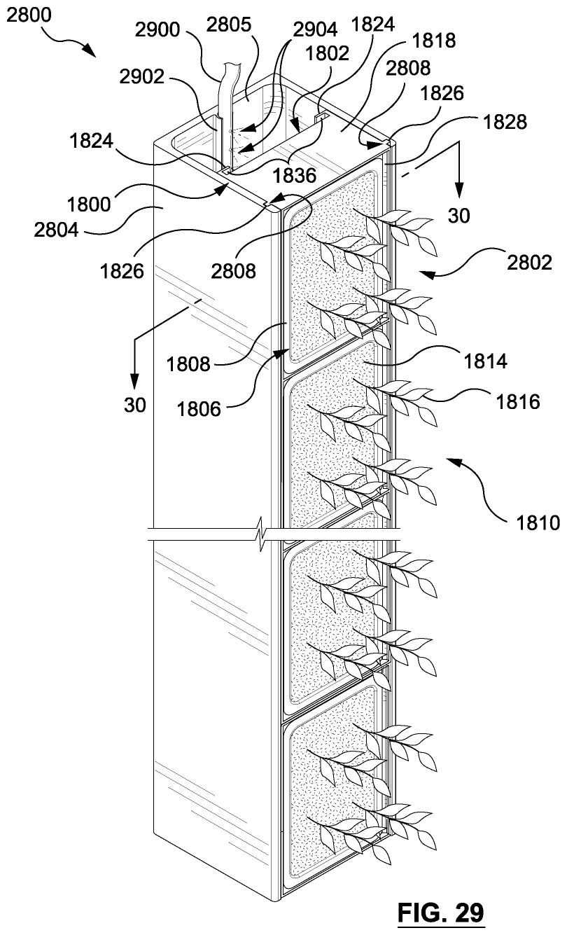

Turning now to FIGS. 28 to 30, which show installation of the second exemplary plant carrier insert 1800 into a second exemplary plant cultivation tower 2800, it can be seen that the second exemplary plant cultivation tower 2800 has a longitudinally extending channel 2802 defined therein and adapted to removably slidably receive the second exemplary plant carrier insert 1800. Like the first exemplary plant cultivation tower 900, in the illustrated embodiment the second exemplary plant cultivation tower 2800 is of generally C-shaped cross section, although in the second exemplary plant cultivation tower 2800 the channel 2802 is formed by the C-shape of the plant cultivation tower 2800 itself, rather than by inward projections. In particular, the second exemplary plant cultivation tower 2800 comprises two opposed, substantially parallel generally planar sidewalls 2804 spaced from one another by a generally planar back wall 2805. The inner faces 2806 of the sidewalls 2804 have opposed longitudinally-extending guide grooves 2808 that are dimensioned to receive the guide rails 1826 on the second exemplary plant carrier insert 1800 so as to maintain the plant carrier insert 1800 within the channel 2802. Thus, the secondary exemplary plant carrier insert 1800 can be slid into the channel 2802. As noted above, the guide rails 1826 are offset relative to one another and the guide grooves 2808 are correspondingly offset as a forcing function so that the secondary exemplary plant carrier insert 1800 can be slid into the channel 2802 in only a single orientation. (A similar approach could be adopted for the guide rails 426 and the guide grooves 908 in the first exemplary plant carrier insert 400 and the first exemplary plant cultivation tower 900, respectively, for the same purpose.) Typically, a series of instances of the second exemplary plant carrier insert 1800 are received in the channel 2802 in end-to-end relation, as shown in FIG. 29. However, depending on the length of the plant carrier insert 1800 and the height of the second exemplary plant cultivation tower 2800, only a single instance of the first exemplary plant carrier insert 1800 may be received in the channel 2802. In either case, the second exemplary plant cultivation tower 2800 is another example of a housing for a plant cultivation system, which comprises a magazine having a longitudinally extending channel 2802 defined therein, and, when the second exemplary plant carrier insert 1800 is installed, the channel 2802 has removably slidably received therein a plurality of distinct individual plant receptacles 1804 arranged in end-to-end relation. Typically the second exemplary plant cultivation tower 2800 will have a similar height to the first exemplary plant cultivation tower 900, i.e. from five feet to eight feet in height, although other heights are also contemplated.

Continuing to refer to FIGS. 28 to 30, the second exemplary plant cultivation tower 2800 is further adapted to receive a misting pipe 2900 within the channel 2802, interiorly of the plant receptacles 1804, the containers 1806 and the plant units 1810. In the illustrated embodiment, a longitudinally-extending generally C-shaped projection 2902 projects inwardly from the back wall 2805 of the second exemplary plant cultivation tower 2800 and runs along the length thereof. As shown in FIGS. 29 and 30, the C-shaped projection 2902 is adapted to clamp the correspondingly sized tubular misting pipe 2900 in an interference fit. The perforations 2904 on the misting pipe are oriented toward the opening of the channel 2802 so that their spray 2906 will be directed at the bottoms 1840 (FIGS. 26 and 27) of the containers 1806 when the second exemplary plant carrier insert 1800 is received in the second exemplary plant cultivation tower 2800. Thus, the spray 2906 from the misting pipe 2900 can pass through the misting apertures 2908 in the bottoms 1840 of the containers 1806 for absorption by the growth medium 1814. The misting pipe 2900 may be coupled to the fertigation system, or to a separate water supply. Although not shown in the drawings, the first exemplary plant cultivation tower 900 may also be adapted to incorporate a misting tube, with suitable apertures added to the first exemplary plant carrier insert 400.

The external footprint of the second exemplary plant cultivation tower 2800 is the same as that of the first exemplary plant cultivation tower 900. As such, the second exemplary plant cultivation tower 2800 and the first exemplary plant cultivation tower 900 can be interchangeably supported in the tower receptacles 130 in the tower return troughs 132 of the exemplary isolation and fertigation infrastructure unit 100. Accordingly, once the plant carrier insert(s) 1800 are positioned in the channel 2802, the entire assembly (plant cultivation tower 2800 and plant carrier insert(s) 1800) may then be installed in one of the tower receptacles 130 in one of the tower return troughs 132 in a manner analogous to that shown for the first exemplary plant cultivation tower 900 in FIGS. 11 to 13.

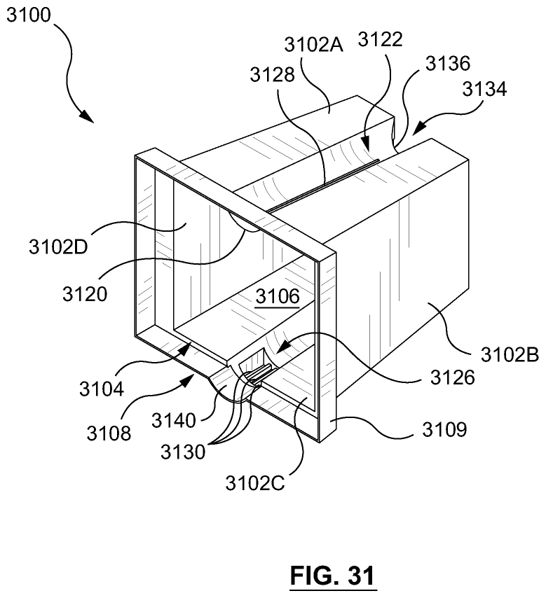

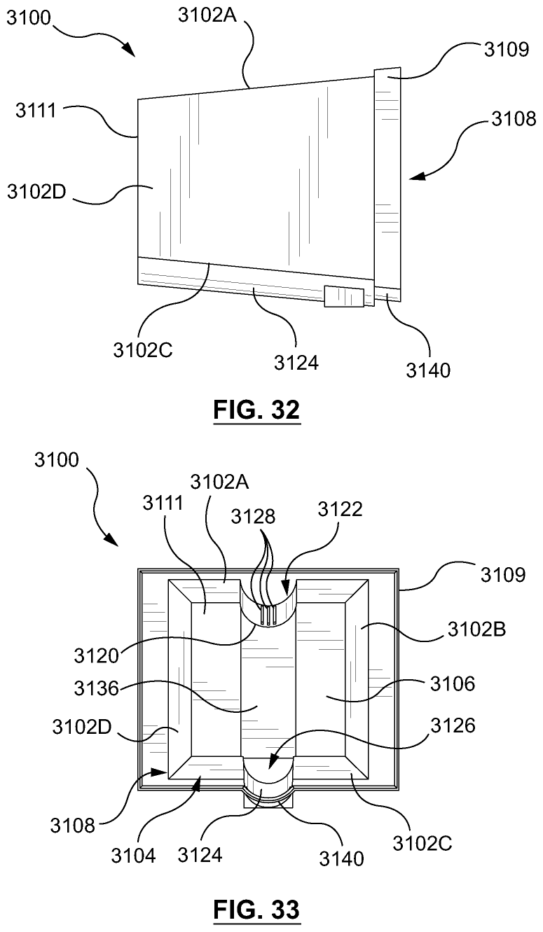

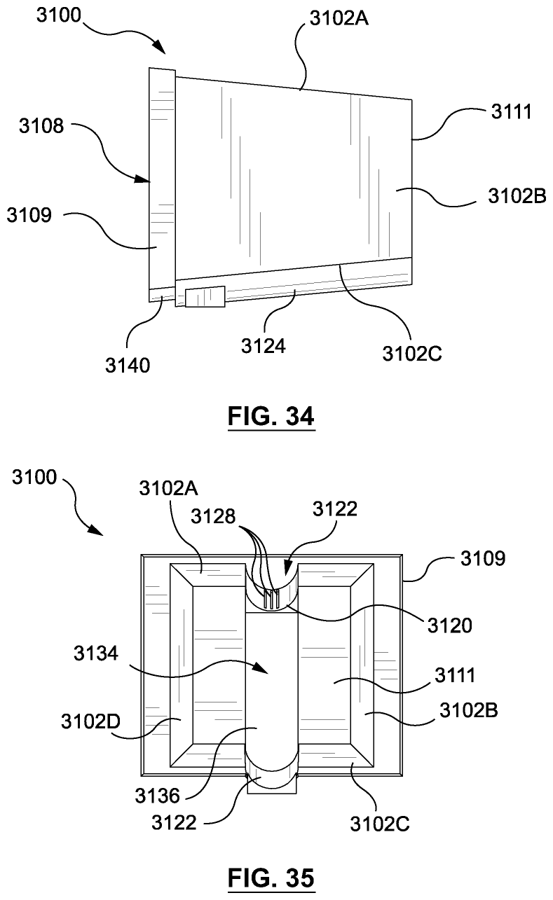

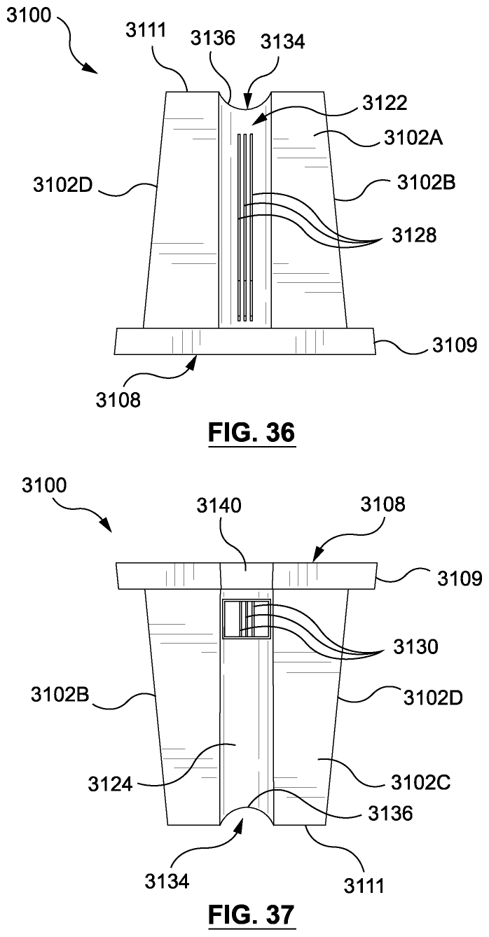

Reference is now made to FIGS. 31 to 37, which show a third exemplary plant carrier insert, indicated generally by reference 3100.

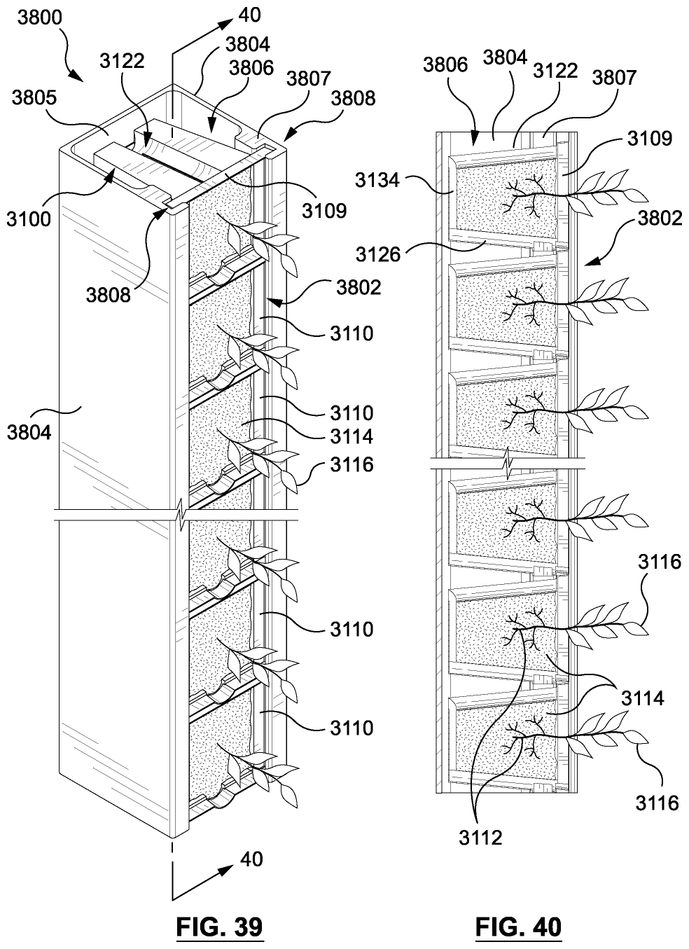

The third exemplary plant carrier insert 3100 is an individual plant container comprising four surrounding sidewalls 3102A, 3102B, 3102C and 3102D forming a plant receptacle 3104 having an interior volume 3106 and adapted to retain plant growth medium 3114 (see FIG. 39) in the interior volume 3106. While the exemplary embodiment shown in FIGS. 31 to 37 has four generally planar sidewalls 3102A, 3102B, 3102C and 3102D in a generally square frusto-pyramidal arrangement, other shapes and configurations having more or fewer sidewalls are also contemplated. For example, other embodiments may have a single sidewall forming a generally cylindrical or frusto-conical shape.

The surrounding sidewalls 3102A, 3102B, 3102C and 3102D define an open cultivation end 3108 of the plant receptacle 3100 adapted for emergence of a plant shoot system 3116 therefrom (see FIG. 39). The plant receptacle 3104 thus accommodates a plant unit 3110 (root system 3112, growth medium 3114 and shoot system 3116). A generally rectangular outwardly flanged upstanding peripheral rim 3109 surrounds the open cultivation end 3108 of the plant receptacle 3100. In the illustrated embodiment, a floor 3111 cooperates with the sidewalls 3102A, 3102B, 3102C and 3102D to define the plant receptacle 3104. The floor 3111 may be closed as shown in the Figures, or may include perforations. In alternate embodiments, for example if the plant growth medium is to be rockwool or a similar material, the floor may be omitted and both ends of the plant receptacle may be open.

An inward projection 3120 is formed in the sidewall 3102A on a first side of the plant container 3100 to define an outwardly facing fertigation supply trough 3122, and an outward projection 3124 is formed in the sidewall 3102C on a second side of the plant container, opposite the first side of the plant container 3100, to define an inwardly facing fertigation drainage trough 3126. The sidewall 3102C may slope toward the fertigation drainage trough 3126. While the illustrated embodiment shows only a single inward projection 3120 forming a single fertigation supply trough 3122, and only a single outward projection 3124 forming a single fertigation drainage trough 3126, in other embodiments there may be a plurality of fertigation supply troughs and a plurality of fertigation drainage troughs.

The fertigation supply trough 3122 has a plurality of fertigation supply apertures 3128 formed therethrough in fluid communication with the interior volume 3106 of the plant receptacle 3104, and the fertigation drainage trough 3126 has a plurality of fertigation drainage apertures 3130 formed therethrough in fluid communication with the interior volume 3106 of the plant receptacle 3104.

As can be seen in the Figures, the fertigation supply trough 3122 and the fertigation drainage trough 3126 each slope inwardly from the open cultivation end 3108 of the plant receptacle 3104. Such sloping may result from the configuration of the sidewall(s), the configuration of the troughs, or a combination of both. A liquid retention lip 3140 is formed in the peripheral rim 3109 at the end of the fertigation drainage trough 3126 adjacent the open cultivation end 3108 of the plant receptacle 3104. To facilitate injection molding, the liquid retention lip 3140 may be formed as a separate piece and affixed at the open cultivation end 3108 of the plant receptacle 3104.

In the exemplary embodiment, an overflow conduit 3134 extends between the fertigation supply trough 3122 and the fertigation drainage trough 3126, bypassing the interior volume 3106 of the plant receptacle 3104. In the illustrated embodiment, the fertigation supply trough 3122 is opposed to and in registration with the fertigation drainage trough 3126 and the overflow conduit 3134 is formed by an inward projection 3136 that is at least partially covered by the floor 3111. The overflow conduit 3134 is in further registration with both the fertigation supply trough 3122 and the fertigation drainage trough 3126; other constructions are also contemplated. As noted above, there may be more than one fertigation supply trough 3122 and/or more than one fertigation drainage trough 3126; there may similarly be more than one overflow conduit.

In the illustrated embodiment, because of the generally frusto-pyramidal shape of the sidewalls 3102A, 3102B, 3102C and 3102D, and because of the position and configuration of the fertigation supply trough 3122, fertigation drainage trough 3126 and overflow conduit 3134, each of the plant containers 3100 is nestable within another of the plant containers 3100. The liquid retention lip 3140 is outwardly bowed to facilitate this nesting.

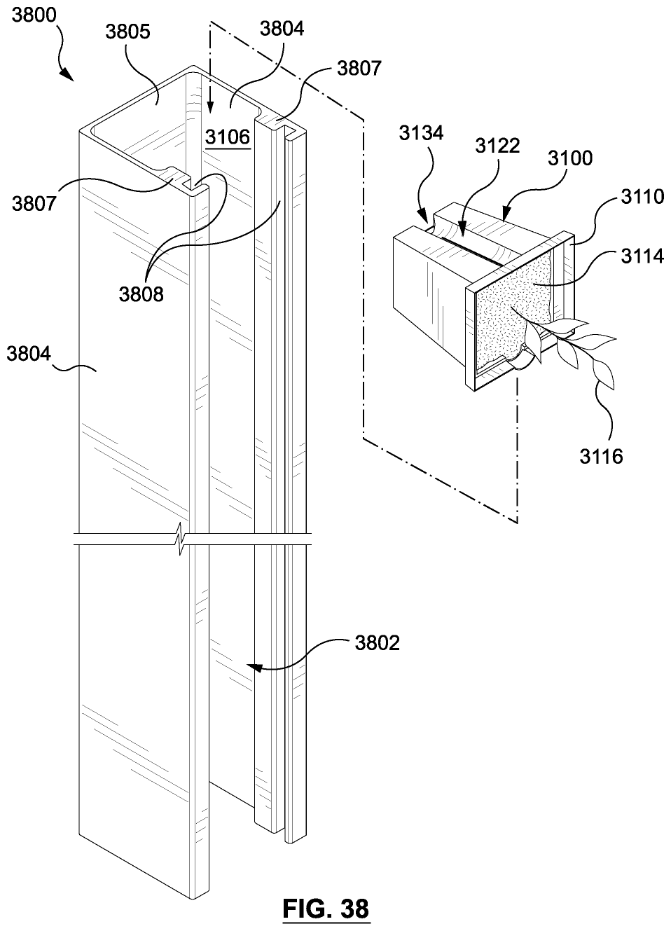

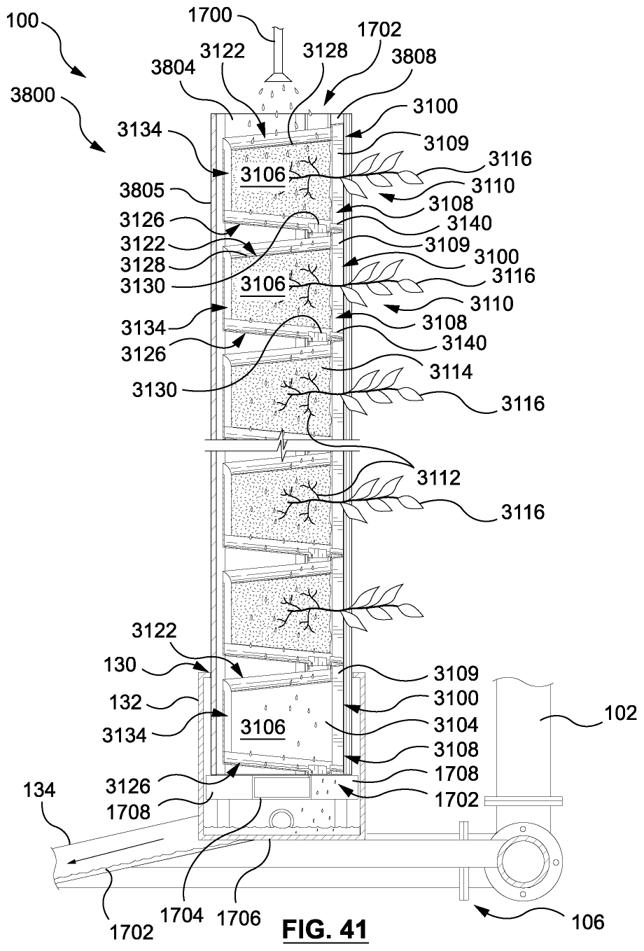

Reference is now made to FIGS. 38 to 40, which show installation of the third exemplary plant carrier insert, i.e. the plant container 3100, into a third exemplary plant cultivation tower 3800. The third exemplary plant cultivation tower 3800 is similar in construction to the second exemplary plant cultivation tower 2800, and has a longitudinally extending channel 3802 defined therein and adapted to removably slidably receive instances of the plant container 3100. Like the second exemplary plant cultivation tower 2800, in the illustrated embodiment the third exemplary plant cultivation tower 3800 is of generally C-shaped cross section. The third exemplary plant cultivation tower 3800 comprises two opposed, substantially parallel generally planar sidewalls 3804 spaced from one another by a generally planar back wall 3805. The inner faces 3806 of the sidewalls 2804 have opposed longitudinally-extending inward projections 3807 in which are formed longitudinally extending guide grooves 3808 that are dimensioned to receive the peripheral rim 3109 of the plant container 3100 so as to maintain the plant container 3100 within the channel 3802. Thus, the plant container 3100 can be slid into the channel 3802. Typically, a series of the plant containers 3100 are received in the channel 3802 in end-to-end relation, as shown in FIGS. 39 to 41.

FIG. 41 shows a series of the plant containers 3100 received in the channel 3802 of the third exemplary plant cultivation tower 3800, which is itself received in a tower receptacle 130 of the exemplary isolation and fertigation infrastructure unit 100. As best seen in FIG. 41, when in use, i.e. when installed in the third exemplary plant cultivation tower 3800, the plant containers 3100 are oriented so that the fertigation supply trough 3122 is facing upward.

The fertigation supply troughs 3122 of all but the uppermost plant container 3100 are arranged in registration with the fertigation drainage trough 3126, and in particular with the fertigation drainage apertures 3130, of the plant container 3100 above. A fertigation tube 1700, supplied by the fertigation pump (not shown) from the fertigation reservoir 120 (FIG. 1) is positioned over the third exemplary plant cultivation tower 3800 registration with the channel 3802 thereof and in further registration with the fertigation supply trough 3122 of the uppermost plant container 3100 to supply water 1702 to the plant units 3110 in the plant receptacles 3104 of the plant containers 3100.

Liquid (e.g. water 1702 from the fertigation tube 1700) received in the fertigation supply trough 3122 of the uppermost plant container flows along the fertigation supply trough 3122 away from the open cultivation end 3108 of the plant receptacle 3104, through the fertigation supply apertures 3128 into the interior volume 3106 of the plant receptacle 3104 to saturate the growth medium 3114 of the plant unit 3110 therein. The water 1702 continues to flow through the interior volume 3106 of the plant receptacle 3104 into the fertigation drainage trough 3126, along the fertigation drainage trough 3126 toward the open cultivation end 3108 of the plant receptacle 3104, and through the fertigation drainage apertures 3130 to exit the interior volume 3106 of the plant receptacle 3104. Because the fertigation supply troughs 3122 of all but the uppermost plant container 3100 are arranged in registration with the fertigation drainage apertures 3130 of the plant container 3100 above, water 1702 exiting the interior volume 3106 of the plant receptacle 3104 through the fertigation drainage apertures 3130 will enter the fertigation supply trough 3122 of the plant container 3100 below. The water 1702 can thus flow through successive plant receptacles 3104 (after saturating the growth medium 3114 of the plant unit 3110 therein) to a lowermost one of the plant receptacles 3104 under the influence of gravity. Additionally, the overflow conduit 3134 extending between the fertigation supply trough 3122 and the fertigation drainage trough 3126 can carry excess water from the fertigation supply trough 3122 to the fertigation drainage trough 3126, bypassing the interior volume 3106 of the plant receptacle 3104, to inhibit spillage when the growth medium 3114 is saturated. The liquid retention lip 3140 likewise inhibits spillage from the end of the fertigation drainage trough 3126 adjacent the open cultivation end 3108 of the plant receptacle 3104.

The lowermost plant container 3100 is shown in FIG. 41 with its plant receptacle 3104 empty since it occupies the portion of the third exemplary plant cultivation tower 3800 that is received in the tower receptacle 130 of the exemplary isolation and fertigation infrastructure unit 100 and functions as a spacer; alternatively the plant cultivation tower may include a spacer. Water 1702 can similarly flow through the fertigation supply trough 3122, interior volume 3106 and/or overflow conduit 3134 to the fertigation drainage trough 3126 of the lowermost plant container 3100, and then through the fertigation drainage apertures 3130 thereof into the tower return trough 132, which feeds into the return tubing 134 to drain the water 1702.

The third exemplary plant cultivation tower 3800 is another example of a housing for a plant cultivation system, which comprises a magazine having a longitudinally extending channel 3802 defined therein, and, when a plurality of the plant containers 3100 are installed, the channel 3802 has removably slidably received therein a plurality of distinct individual plant receptacles 3104 arranged in end-to-end relation. Typically the third exemplary plant cultivation tower 3800 will have a similar height to the first exemplary plant cultivation tower 900 and the second exemplary plant cultivation tower 2800, i.e. from five feet to eight feet in height, although other heights are also contemplated.

Various examples of modular magazines (e.g. towers) and plant carrier inserts have been shown and described for purposes of illustrating the principles encompassed by the present disclosure; it is to be understood that these are merely illustrative embodiments and are not intended to circumscribe or limit the scope of the claims.

More broadly, the present disclosure describes a method for cultivating plants comprising placing a seed into a quantity of plant growth medium in a plant receptacle in a plant carrier insert, installing the plant carrier into a plant cultivation tower, installing the plant cultivation tower upright in an isolation and fertigation unit, and fertigating the plant growth medium while providing an air curtain over the plant receptacles until the plant reaches a desired stage of growth. The fertigation may be achieved by fertigating an uppermost plant receptacle and allowing the fertigation liquid to descend through successively lower plant receptacles under gravity. After the plant has reached the desired stage of growth, the plant cultivation tower is removed from the isolation and fertigation unit and the plant carrier insert is removed from the plant cultivation tower for further processing.

The drawings show plants already having sprouted in order to facilitate illustration, it is to be appreciated that seeds may be placed in growth medium in the plant receptacles and allowed to sprout while the plant carrier inserts are installed in plant cultivation towers received in the isolation and fertigation infrastructure unit.

Although not shown in the drawings, it is also contemplated that that plant cultivation towers as described herein may be adapted to aquaponics applications by having the towers adapted to removably receive a float on either side of the channel to buoyantly support the tower with the channel upright within a body of water. A plurality of such towers could then be arranged horizontally rather than vertically, floating in water via the floats, longitudinally parallel to one another, with a plurality of plant carrier inserts with plant units received in the channels, to form an aquaponics assembly.

Certain exemplary embodiments have been described by way of example. It will be apparent to persons skilled in the art that a number of variations and modifications can be made without departing from the scope of the invention as defined in the claims.

What is claimed is:

1. A housing for a plant cultivation system, comprising:
a tower;
the tower has a longitudinally extending channel defined therein;
the channel being adapted to removably slidably receive a plant carrier.

2. The housing of claim 1, wherein the tower is adapted to receive a misting pipe within the channel, interiorly of the plant carrier.

3. A plant carrier insert for a plant cultivation tower, comprising:
a longitudinally extending support element;
the support element having a plurality of longitudinally spaced receptacles;
each of the receptacles being adapted to receive and support a plant unit;
each of the receptacles having a fertigation port in fluid communication with an adjacent one of the receptacles;
whereby, when the support element is oriented vertically, fluid supplied to an uppermost one of the receptacles can flow through the fertigation ports through successive receptacles to a lowermost one of the receptacles.

4. The plant carrier of claim 3, wherein:
each fertigation port comprises at least one aperture formed through a respective partition separating adjacent ones of the receptacles.

5. The plant carrier of claim 4, wherein a concave region surrounds each fertigation port.

6. The plant carrier of claim 2, wherein each of the receptacles is adapted to releasably receive a clamshell housing.

7. A housing for a plant cultivation system, comprising:
a magazine;
the magazine having a longitudinally extending channel defined therein;
the channel having removably slidably received therein a plurality of distinct individual plant receptacles in end-to-end relation.

8. The housing of claim 7, wherein the magazine is adapted to receive a misting pipe within the channel, interiorly of the plant receptacles.

9. A plant container, comprising:
at least one surrounding sidewall forming a plant receptacle having an interior volume and adapted to retain plant growth medium in the interior volume;
the at least one surrounding sidewall defining an open cultivation end of the plant receptacle adapted for emergence of a plant shoot system therefrom;
at least one inward projection formed in the at least one sidewall on a first side of the plant container to define an outwardly facing fertigation supply trough;
the fertigation supply trough having at least one fertigation supply aperture formed therethrough in fluid communication with the interior volume of the plant receptacle;
at least one outward projection formed in the at least one sidewall on a second side of the plant container, opposite the first side of the plant container, to define an inwardly facing fertigation drainage trough;
the fertigation drainage trough having at least one fertigation drainage aperture formed therethrough in fluid communication with the interior volume of the plant receptacle;
the at least one fertigation supply trough and the at least one fertigation drainage trough each sloping inwardly from the open cultivation end of the plant receptacle;
whereby, in use, when the plant container is oriented so that the at least one fertigation supply trough is facing upward, liquid received in the fertigation supply trough flows along the fertigation supply trough away from the open cultivation end of the plant receptacle, through the at least one fertigation supply aperture into the interior volume of the plant receptacle, through the interior volume of the plant receptacle into the fertigation drainage trough, along the fertigation drainage trough toward the open cultivation end of the plant receptacle, and through the at least one fertigation drainage aperture to exit the interior volume of the plant receptacle.

10. The plant container of claim 9, further comprising:
at least one overflow conduit extending between the at least one fertigation supply trough and the at least one fertigation drainage trough to carry excess liquid from the at least one fertigation supply trough to the at least one fertigation drainage trough;
the at least one overflow conduit bypassing the interior volume of the plant receptacle.

11. The plant container of claim 9, wherein each fertigation supply trough is opposed to and in registration with a respective corresponding one of the at least one fertigation drainage trough.

12. A plurality of plant containers according to claim 11, wherein each of the plant containers is nestable within another of the plant containers.

13. The plant container of claim 9, wherein a liquid retention lip is disposed at an end of the fertigation drainage trough adjacent the open cultivation end of the plant receptacle.

14. The plant container of claim 9, further comprising a floor opposite the open cultivation end of the plant receptacle, the floor cooperating with the at least one sidewall to define the plant receptacle.
